(19) United States
(12) Patent Application Publication
(10) Pub. No.: US 2014/0295828 A1
(43) Pub. Date: Oct. 2, 2014

(54) Methods and Apparatuses Enabling Selection Between Cellular and Non-Cellular Radio Connections

(71) Applicant: Broadcom Corporation, Irvine, CA (US)

(72) Inventors: Ekaterina Pogosova, Tampere (FI); Hannu Tapani Talvitie, Tampere (FI); Kim Henrik Kaltiokallio, Helsinki (FI); Jari Juhani Ruohonen, Tampere (FI)

(73) Assignee: Broadcom Corporation, Irvine, CA (US)

(21) Appl. No.: 14/225,875

(22) Filed: Mar. 26, 2014

(30) Foreign Application Priority Data
Mar. 27, 2013 (GB) 1305629.6

(51) Int. Cl. H04W 76/02; H04W 36/00; H04W 88/06

(52) U.S. Cl. CPC H04W 76/026; H04W 88/06; H04W 36/0022
USPC 455/426.1; 455/553.1

(57) ABSTRACT

A modulator/demodulator apparatus obtains layer 1 measurements and/or estimations for cellular and non-cellular radio performance characteristics, and performs an evaluation based on at least the layer 1 measurements and/or estimations for selecting a connection to cellular or non-cellular radio. The apparatus provides information on results of the evaluation to a connection manager located in an upper layer, for performing a final decision on the connection to cellular or non-cellular radio, or obtains information supporting selection of a connection to cellular or non-cellular radio from the connection manager and performs a final decision on the connection to cellular or non-cellular radio based on results of the evaluation and the information from the connection manager for selecting the connection to cellular or non-cellular radio.

### FIELD OF THE INVENTION

The present invention relates to methods and apparatuses enabling selection between cellular and non-cellular connections. In particular, the invention relates to a mechanism that allows a mobile device to perform the selection between cellular and non-cellular radio connections, taking into account performance characteristics of both cellular and non-cellular links.

### BACKGROUND OF THE INVENTION

The following meanings for the abbreviations used in this specification apply:

3G Third Generation

ANDSF Access Network Discovery and Selection Function

CM Connection Manager

DSMIPv6 Dual Stack implementation if Mobile IP version 6

HW Hardware

IP Internet Protocol

L1 Layer 1, the physical layer in the OSI reference model

L2/3 Layers 2,3 in the OSI reference model

LTE Long Term Evolution

OSI Open Systems Interconnection

RF Radio Frequency

RSRP Reference Signal Received Power

RSRQ Reference Signal Received Quality

RSSI Received Signal Strength Indication

SCM Shadow Connection Manager

SW Software

With the explosion of mobile data usage, offloading traffic from cellular to WiFi networks is becoming more and more popular. The offloading takes place already today as most of the smart phones have WiFi capability. However, the current offloading principle is very simple and does not involve much intelligence: WiFi connection is used for the data traffic whenever there is a “known” WiFi network in the range. Such simple connection manager related functionality already exists within operating system frameworks (such as e.g. Android Connectivity Service). Future offloading solutions however need to be much more intelligent, as they need to take into account multiple decision criteria.

The problem of developing more advanced offloading solutions, that would take multiple parameters into account in the decision making process, is already starting to be addressed in the industry. These solutions are commonly called Connection Managers (CM). However, the proposed solutions typically involve application level or operating system level solutions that do not involve any low level algorithms associated with communication layers 1, 2, 3 of cellular (2G/3G/4G) and non-cellular (WiFi) radios, except perhaps signal strength measurements. This is quite natural, since today's typical mixed cellular and non-cellular modems are usually built up from independent components, and moreover, there are typically different suppliers for cellular and non-cellular HW platforms/chips, which implies totally different solutions and no interaction between the radios at low levels, i.e. communication layers 1, 2, 3. Such high level solutions cannot be optimal in terms of measuring various parameters associated to each of the radios (cellular and non-cellular), as they are generally rather limited.

Most of the earlier proposed solutions on this topic are based on high (usually OS) level implementations and thus do not cover the aspects described in current invention.

In a reference entitled 3G LTE Wifi Offload Framework: Connectivity Engine (CnE) to Manage Inter-System Radio Connections and Applications by Qualcomm, Jun. 20, 2011, http://www.qualcomm.com/media/documents/qualcomm-research-3g-lte-wifi-offload-framework, aspects are described that need to be covered by an intelligent offloading solution, namely, 1) a mechanism to provide operators' policy input, 2) a mechanism to allow seamless handovers, and 3) algorithms in the device to detect characteristics of unplanned Wi-Fi networks.

The first aspect describes usage of ANDSF framework. The second aspect is related to using DSMIPv6 for the flow mobility. The third aspect proposes metrics that need to be measured regarding network characteristics at the mobile device.

### BRIEF DESCRIPTION OF THE DRAWINGS

FIG. 1 shows a flowchart illustrating a process 1 of enabling selection between cellular and non-cellular connections according to a first exemplary embodiment of the invention.

FIG. 2 shows a flowchart illustrating a process 2 of enabling selection between cellular and non-cellular connections according to a second exemplary embodiment of the invention.

FIG. 3 shows a schematic block diagram illustrating a structure of a modulator/demodulator apparatus according to an exemplary embodiment of the invention.

FIG. 4 shows a schematic block diagram illustrating a configuration of a control unit in which examples of embodiments of the invention are implementable.

FIG. 5 shows a block diagram illustrating a principle of an SCM according to the first exemplary embodiment of the invention.

FIG. 6 shows a block diagram illustrating a principle of an SCM according to the second exemplary embodiment of the invention.

### DETAILED DESCRIPTION

The present invention aims at overcoming the above-described problems and at providing a common shared environment for evaluating characteristics of radio links using a generic approach for cellular and non-cellular radios. According to at least one exemplary embodiment of the invention, this generic mechanism is associated with layers 1, 2, 3 of cellular and non-cellular radio protocols and belongs to Modem IP delivery.

This is achieved by the methods and apparatuses as defined in the appended claims. The invention may also be implemented by a computer program product.

At least one exemplary embodiment of the invention concentrates on an SCM that is located inside a modem within an L2/L3 shared cellular/non-cellular modem processing subsystem. The SCM collects low level (L1) measurement results of both cellular and WiFi radios, and based on these results selects technically the best radio connection. After that the SCM either: 1) provides the results of these measurements to an upper layers connection manager (CM) that performs the final decision regarding the connection, or 2) performs the final decision on the connection based on its own evaluation results as well as information obtained from the upper layers CM.

The SCM is implemented at low levels of modem firmware, which evaluates different radio connections and communicates with the upper layers connection manager that may be e.g. on an application or operating system level. Final intelligent decision regarding the radio connection is performed based on the SCM evaluation along with other criteria, known to the upper layers connection manager, such as operator policies, user preferences, etc.

The feedback, provided by the SCM, can be used by the actual connection manager independently of its location and other details. The actual connection manager does not have to rely on the very limited and often non-comparable characteristics provided by different cellular/non-cellular chip suppliers, neither it has to perform its own high level measurements (that can be rather slow) for evaluating the radio links. Instead, it can rely on technical information obtained from the SCM which is part of modem IP delivery, and use it along with other (less technical) information to perform the decision on the connection.

Alternatively, the final decision making task can be moved from the CM to the SCM. In this case, faster connection setup time can be provided.

The invention relates to a concept of implementing cellular and non-cellular radios with shared low level processing resources, and to developing a low level common infrastructure for evaluating cellular and non-cellular radio connections based on measurement results of various performance characteristics both for cellular and non-cellular radios, supporting an offloading decision.

According to at least one exemplary embodiment of the invention, a general principle is proposed for a CM associated with a concept called “Shadow Connection Manager” (SCM). The SCM takes advantage of a tight coupling of cellular and WiFi radios with shared HW/SW processing resources for communication layers 1, 2,3. Alternatively, the SCM can assume separate processing resources for layer 1, but shared resources for layers 2,3. The SCM provides means for low level measurements and evaluation. Thus, unlike upper layers CMs, the SCM is located on the modem side within the L2/L3 modem processing architecture.

In the following, several scenarios will be described. In one scenario, the SCM provides its feedback regarding the best (in terms of performance characteristics) radio connection to the upper layers CM that performs a final intelligent decision. In another scenario, the SCM collects possible available information from the CM and performs the final decision on the radio connection by itself based on this information along with its own evaluation of performance characteristics.

In a cellular only context, the problem of selection between different radios (3G/4G) generally belongs to a base station which can take into account some parameters provided by a mobile device, such as RSRP and RSRQ in the case of LTE. With the increased importance of WiFi offloading, the obvious question is how to perform the selection not only among different cellular radios, but also between cellular and non-cellular radios. In the latter case the selection should be made at the mobile terminal, since WiFi is outside today's base station scope.

The problem of performing selection between cellular and non-cellular radios at the mobile terminal based on various characteristics of both types of connections is rather new. Thus, there are typically not many low level measurement results that can be extracted from cellular and WiFi chips. The only parameters typically available from the chips/chipsets are signal strength values used for signal bars. However, e.g. the RSSI value for WiFi is a very relative number as it is vendor dependent, thus it does not represent the actual absolute signal strength.

Most of today's cellular and WiFi chips are provided by different suppliers. Generally, measurement results for different radios (cellular/non-cellular) and from different vendors can be hard to compare and the comparison often might not reflect the actual situation. Also, the signal strength value alone is not sufficient to make conclusions regarding connection quality.

The above described factors imply that the connection managers cannot take advantage of a radio quality evaluation performed by the cellular/non-cellular chips/chipsets that run radio protocol stacks. Any possible measurements need to be implemented at the upper layers (i.e. application level or operating system level), which results in non-optimal overall connection manager solution.

As mentioned above, an approach of the invention is the infrastructure, referred to as SCM, located in the modem firmware, in particular, in a common shared L2/L3 cellular/non-cellular architecture. The SCM analyzes various measurement results, obtained from low level (at least L1) measurements, and communicates with the upper layers CM.

In one exemplary embodiment of the invention, the SCM performs radio evaluation based on the L1 measurement results and its own algorithms. The final decision making regarding a radio connection is retained to the CM, which takes into account the feedback, provided by the SCM, along with other information.

In another embodiment of the invention, decision making functionality can be moved from the CM to the SCM. In this case, the upper layers CM can provide the required parameters to the SCM at the same time while SCM performs radio evaluation. The SCM then uses the information, provided by the CM, along with own evaluation results to perform the final decision for the radio connection at a particular time for a particular use case. This allows for a faster data connection setup time since information does not need to be circulated between the modem and the application side.

FIG. 1 illustrates a process 1 of enabling selection between cellular and non-cellular radio connections according to a first exemplary embodiment of the invention. The process 1 may be executed by an SCM located in a modulator/demodulator apparatus. The modulator/demodulator apparatus may be part of a user equipment (UE).

In step S11, layer 1 (L1) measurements and/or estimations for cellular and non-cellular radio performance characteristics are obtained.

In step S12, an evaluation based on at least the layer 1 measurements and/or estimations is performed for selecting a connection to cellular or non-cellular radio.

In step S13, information on results of the evaluation is provided to a connection manager (CM) located in an upper layer, for performing a final decision on the connection to cellular or non-cellular radio.

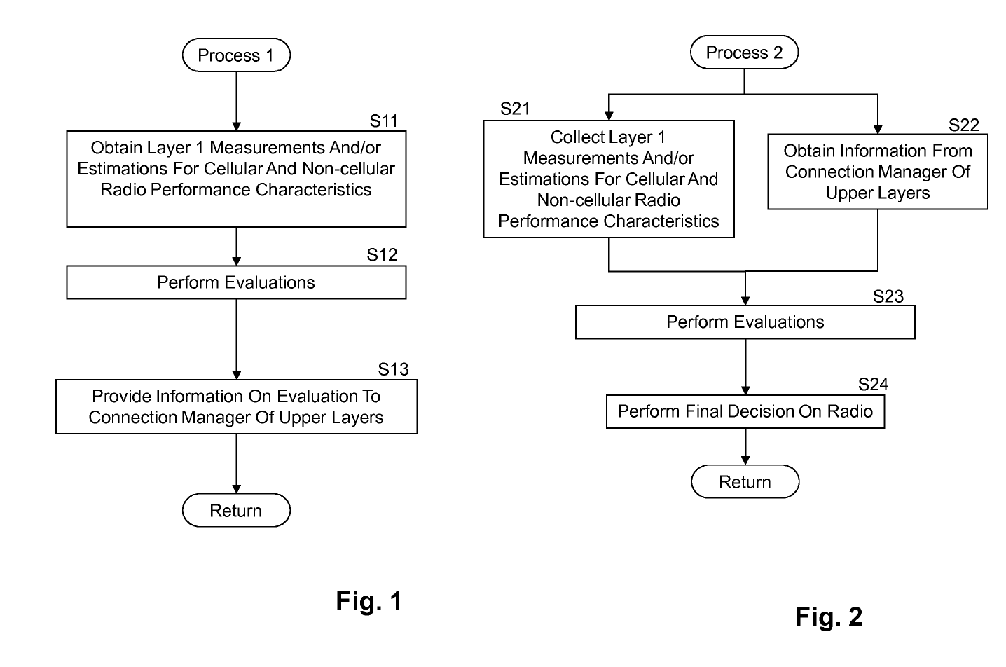

FIG. 2 illustrates a process 2 of enabling selection between cellular and non-cellular radio connections according to a second exemplary embodiment of the invention. The process 2 may be executed by an SCM located in a modulator/demodulator apparatus. The modulator/demodulator apparatus may be part of a user equipment (UE).

In step S21, layer 1 (L1) measurements and/or estimations for cellular and non-cellular radio performance characteristics are obtained.

In step S22 which may be performed independently from step S21, i.e. in parallel to step S21, information supporting selection of a connection to cellular or non-cellular radio is obtained from a connection manager (CM) located in an upper layer.

In step S23 which follows steps S21 and S22, an evaluation is performed based on at least the layer 1 measurements and/or estimations.

In step S24, a final decision on the connection to cellular or non-cellular radio is performed based on results of the evaluation and the information from the connection manager for selecting the connection to cellular or non-cellular radio.

According to another exemplary embodiment, in process 1 and/or process 2, layer 2/layer 3 measurements are collected along with layer 1 measurements and the evaluation is performed using the layer 1/layer 2/layer 3 measurements.

For example, the layer 2/layer 3 measurements comprise throughput and/or latency.

For example, the layer 1 measurements and/or estimations for cellular and non-cellular radio performance characteristics comprise at least one of the following group: signal strength, signal quality, latency, throughput, and power.

For example, the information supporting selection of a connection to cellular or non-cellular radio comprises operator policies and/or user preferences.

According to an exemplary embodiment, the SCM is located in a common shared layer 2/layer 3 cellular/non-cellular architecture of the modulator/demodulator apparatus.

FIG. 3 shows a schematic block diagram illustrating a structure of an modulator/demodulator apparatus 30 according to an exemplary embodiment of the invention. The modulator/demodulator apparatus 30 comprises a cellular physical hardware 31, a non-cellular physical hardware 32, a first processing device 33 and a second processing device 34. It is to be noted that the cellular physical hardware 31 and the non-cellular physical hardware 32 can be also shared, i.e. these two are not necessarily a separate HW. The first processing device 33 and the cellular physical hardware 31 are connected via a link 35, and the first processing device 33 and the non-cellular physical hardware 32 are connected via a link 36. Further, the first processing device 33 and the second processing device 34 are connected via a communication link (communication unit) 37.

According to an exemplary embodiment, the first processing device 33 performs layer 1 control processing, and the second processing device 34 performs a common shared layer 2/layer 3 cellular/non-cellular processing.

The processes 1 and 2 may be executed by the second processing device 34 including the above-described SCM, and the first processing device 33 together with the cellular physical hardware 31 and the non-cellular physical hardware 32 performs the layer 1 measurements and/or estimations for cellular and non-cellular radio performance characteristics. The layer 1 measurements and/or estimations are transferred to the second processing device 34 via the communication link 37.

According to another exemplary embodiment, the first and second processing devices 33, 34 perform a common shared layer 1/layer 2/layer 3 cellular/non-cellular processing, and together with the cellular physical hardware 31 and the non-cellular physical hardware 32 executed process 1 and/or process 2 and the layer 1 measurements and/or estimations for cellular and non-cellular radio performance characteristics.

The information on the results of the evaluation may be transferred to the connection manager located in the upper layer, and/or the information supporting selection of the connection to cellular or non-cellular radio may be obtained from the connection manager located in the upper layer via a second communication link (communication unit) 38.

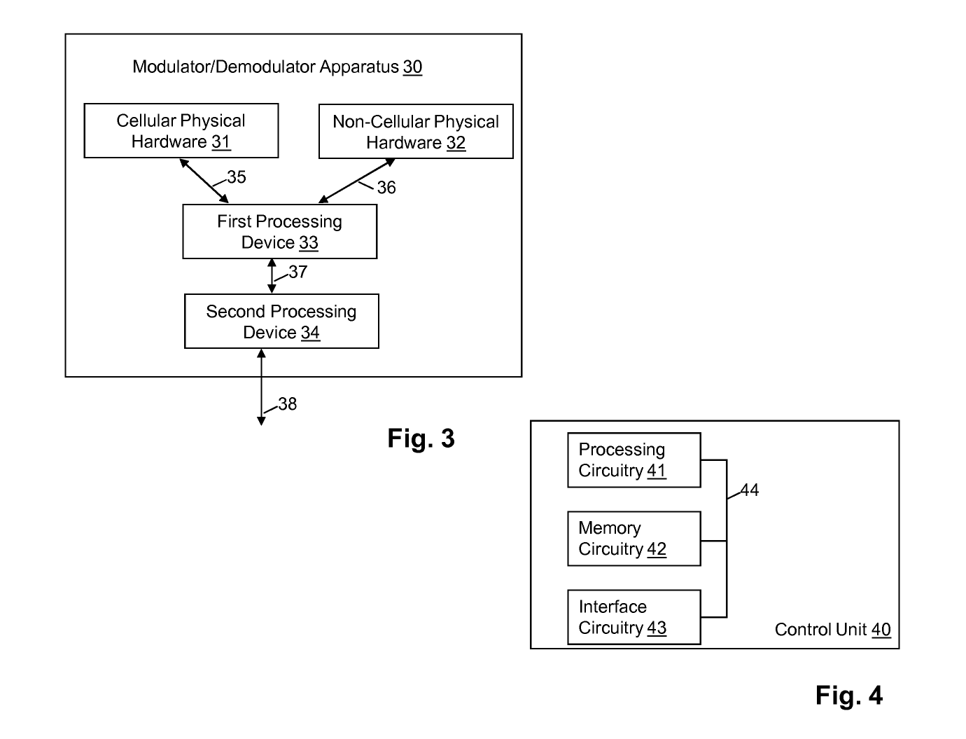

The processes 1 and 2 and/or the modulator/demodulator apparatus 30 may be implemented by the control unit 40 shown in FIG. 4. The control unit 40 comprises a processing circuitry 41, a memory circuitry 42 and an interface circuitry 43 which are connected via a link 44. The memory circuitry 42 may store a program. The interface circuitry 43 includes a suitable radio frequency (RF) transceiver coupled to one or more antennas (not shown) for bidirectional wireless communications over one or more wireless links e.g. with a base station.

The terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and printed electrical connections, as well as by the use of electromagnetic energy, such as electromagnetic energy having wavelengths in the radio frequency region, the microwave region and the optical (both visible and invisible) region, as non-limiting examples.

The program stored in the memory circuitry 42 is assumed to include program instructions that, when executed by the processing circuitry 41, enable the electronic device to operate in accordance with the exemplary embodiments of this invention Inherent in the processing circuitry 41 is a clock to enable synchronism among the various apparatus for transmissions and receptions within the appropriate time intervals and slots required, as the scheduling grants and the granted resources/subframes are time dependent.

In general, the exemplary embodiments of this invention may be implemented by computer software stored in the memory circuitry 42 and executable by the processing circuitry 41, or by hardware, or by a combination of software and/or firmware and hardware.

Examples of an UE including the modulator/demodulator apparatus 30/the control unit 40 include, but are not limited to, mobile stations, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The memory circuitry 42 may be of any type suitable to the local technical environment and may be implemented using any suitable data storage technology, such as semiconductor-based memory devices, magnetic memory devices and systems, optical memory devices and systems, fixed memory and removable memory. The processing circuitry 41 may be of any type suitable to the local technical environment, and may include one or more of general purpose computers, special purpose computers, microprocessors, digital signal processors (DSPs) and processors based on a multi-core processor architecture, as non-limiting examples.

Further, as used in this application, the term “circuitry” refers to all of the following:
a) hardware-only circuit implementations (such as implementations in only analog and/or digital circuitry) and
b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and
c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

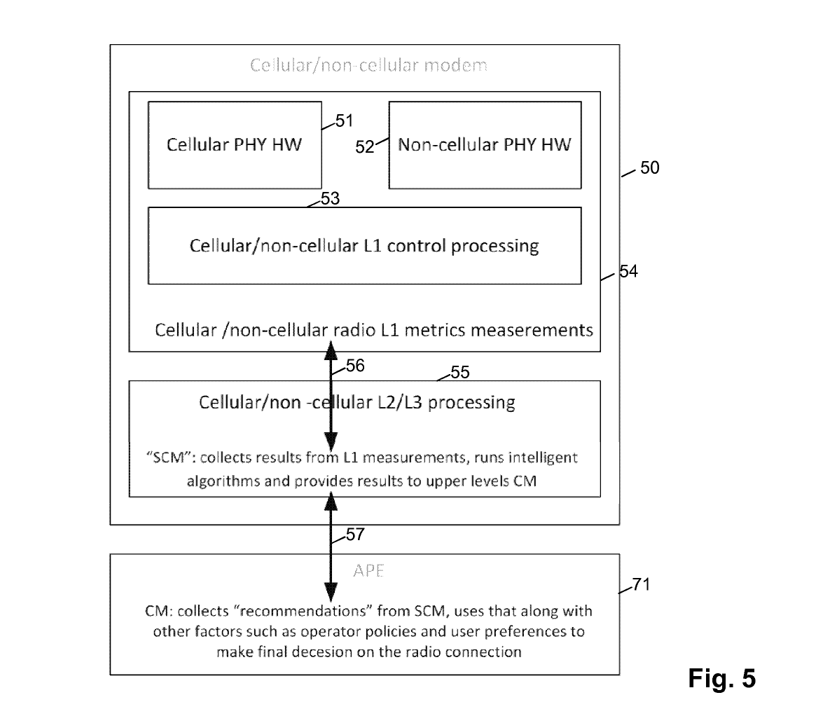

FIG. 5 shows a block diagram illustrating a principle of an SCM according to the first exemplary embodiment of the invention.

As depicted in FIG. 5, a cellular/non-cellular modem 50 comprises a cellular physical hardware block 51, a non-cellular physical hardware block 52, and a cellular/non-cellular L1 control processing block 53, which belong to a L1 subsystem 54. The blocks 51-53 perform cellular/non-cellular radio L1 metrics measurements. Block 53 may include one or several CPUs.

The cellular/non-cellular modem 50 further comprises a cellular/non-cellular L2/L3 processing block 55 in which the SCM is implemented and collects results from L1 measurements via a link 56, runs intelligent algorithms and provides results to an upper levels CM in an application engine (APE) block 71 via a link 57. The CM collects “recommendations” from the SCM, uses that along with other factors such as operator policies and user preferences to make a final decision on a radio connection. Block 55 may include one or several CPUs.

In an exemplary embodiment, the cellular/non-cellular modem 50 corresponds to the modulator/demodulator 30 depicted in FIG. 3, block 51 corresponds to block 31, block 52 corresponds to block 32, block 53 corresponds to block 33, and block 55 corresponds to block 34.

In the diagram of FIG. 5, modem baseband can be on the same or different chips with RF. Also the application engine (APE) can be on the same or different chips with the modem baseband.

The approach illustrated in FIG. 5 can be described in the following three steps:
1. Layer 1 measurements/estimations are performed for cellular and non-cellular radio performance characteristics, such as signal strength, latency, throughput, power, and other relevant characteristics, by the L1 subsystem 54, using a generic approach for all radios. Measurement results from cellular and non-cellular L1 are passed to the common shared L2/L3 processing block 55 via link 56.
2. L2/L3 processing block 55 provides a common cellular and non-cellular infrastructure for
   a) collecting L1 measurement results,
   b) running intelligent algorithms to select the best connection based on the obtained technical characteristics of radio links,
   c) providing feedback to the upper layers connection manager on application or operating system side.
This infrastructure is referred to as “Shadow Connection Manager” (SCM).
3. The actual upper layers CM uses the feedback from SCM along with other possible criteria, such as operator policies, user preferences, or other possible criteria, to perform the final decision for the radio connection at a particular time for a particular use case.

It is to be noted that partially the evaluation described in step 2b of the above algorithm can be performed by the L1 subsystem 54, which may have better knowledge of certain characteristics, such as radio conditions, power levels or RF physical parameters. Thus, e.g. power estimations can be done within the L1 subsystem 54.

It is also noted that the SCM, described in step 2 of the above algorithm is not restricted only to utilizing measurement results obtained from the L1 subsystem 54, but can perform also additional measurements by itself. For example, if the L2/L3 CPU (i.e. block 55) runs a common cellular and non-cellular TCP/IP stack, in this case it is possible to send actual data packets through both cellular and non-cellular networks for additional measurements regarding throughput and latency. In other words, the task that is typically assumed to be done at the upper layers can be performed also by the shared L2/L3 cellular/non-cellular processing block 55.

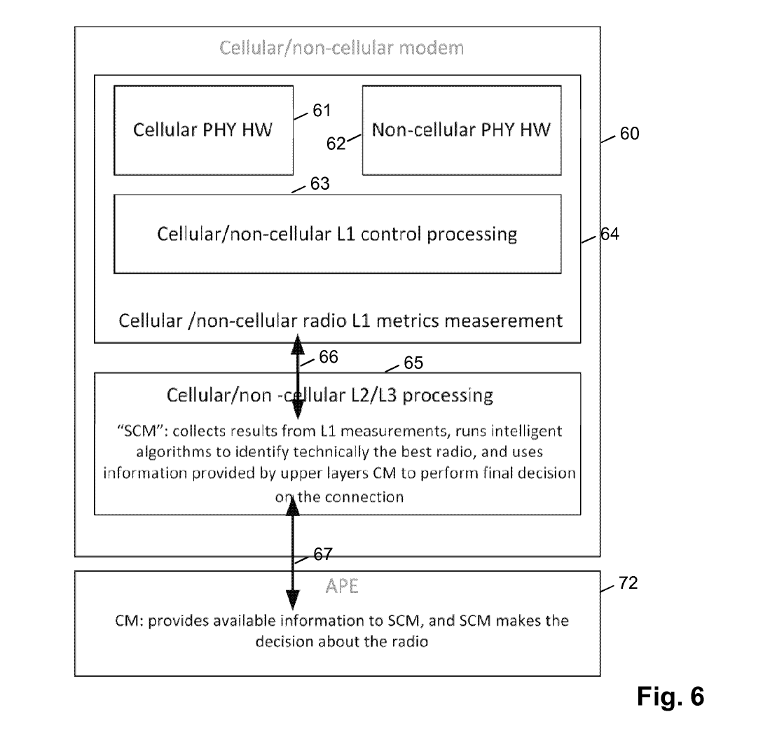

FIG. 6 shows a block diagram illustrating a principle of an SCM according to the second exemplary embodiment of the invention.

As depicted in FIG. 6, a cellular/non-cellular modem 60 comprises a cellular physical hardware block 61, a non-cellular physical hardware block 62, and a cellular/non-cellular L1 control processing block 63, which belong to a L1 subsystem 64. The blocks 61-63 perform cellular/non-cellular radio L1 metrics measurements. Block 63 may include one or several CPUs.

The cellular/non-cellular modem 60 further comprises a cellular/non-cellular L2/L3 processing block 65 in which the SCM is implemented and collects results from L1 measurements via a link 66, runs intelligent algorithms to identify technically the best radio connection, and uses information provided by an upper layers CM in an application engine (APE) block 72 via a link 67 to perform a final decision on the radio connection. The CM provides available information to the SCM, and the SCM makes the decision about the radio connection. Block 65 may include one or several CPUs.

In an exemplary embodiment, the cellular/non-cellular modem 60 corresponds to the modulator/demodulator 30 depicted in FIG. 3, block 61 corresponds to block 31, block 62 corresponds to block 32, block 63 corresponds to block 33, and block 65 corresponds to block 34.

Like in the previous case shown in FIG. 6, the modem baseband can be on the same or different chips with RF. Also the application engine can be on the same or different chips with the modem baseband.

The approach illustrated in FIG. 6 can be described in the following 3 steps:
1. Layer1 measurements/estimations are performed for cellular and non-cellular radio performance characteristics, such as signal strength, latency, throughput, power, and other relevant characteristics, by the L1 subsystem 64, using a generic approach for all radios. Measurement results from cellular and non-cellular L1 subsystem 64 are passed to the common shared L2/L3 processing block 65 via link 66.
2. The upper layers CM in block 72 provides available information, such as operator policies, user preferences, etc., to the SCM via link 67.
3. L2/L3 processing block 65 provides common cellular and non-cellular infrastructure for
   a) collecting L1 measurement results,
   b) running intelligent algorithms to select the best radio connection based on the obtained technical characteristics of the links,
   c) collecting available information from the upper layers CM,
   d) performing the final decision about the radio connection at a particular time for a particular use case based on information available from 3b. and 3c.
This infrastructure is referred to as “Shadow Connection Manager” (SCM).

According to at least one exemplary embodiment of the invention, a common shared environment for evaluating characteristics of radio links using a generic approach for cellular and non-cellular radios is provided. This generic mechanism is associated with layers 1, 2, 3 of cellular and non-cellular radio protocols and belongs to Modem IP delivery.

According to an aspect of the invention, an apparatus for use by a user equipment is provided. According to an exemplary embodiment, the apparatus comprises the modulator/demodulator apparatus 30, and functionality of the apparatus is implemented by the control unit 40.

The apparatus comprises means for obtaining layer 1 measurements and/or estimations for cellular and non-cellular radio performance characteristics, means for performing an evaluation based on at least the layer 1 measurements and/or estimations for selecting a connection to cellular or non-cellular radio, and means for providing information on results of the evaluation to a connection manager located in an upper layer, for performing a final decision on the connection to cellular or non-cellular radio.

According to another aspect of the invention, an apparatus for use by a user equipment is provided. According to an exemplary embodiment, the apparatus comprises the modulator/demodulator apparatus 30, and functionality of the apparatus is implemented by the control unit 40.

The apparatus comprises means for obtaining layer 1 measurements and/or estimations for cellular and non-cellular radio performance characteristics, means for obtaining information supporting selection of a connection to cellular or non-cellular radio from a connection manager located in an upper layer, means for performing an evaluation based on at least the layer 1 measurements and/or estimations, and means for performing a final decision on the connection to cellular or non-cellular radio based on results of the evaluation and the information from the connection manager for selecting the connection to cellular or non-cellular radio.

According to an exemplary embodiment, the apparatuses of the above aspects each comprise means for collecting layer 2/layer 3 measurements in addition to the layer 1 measurements, wherein the means for performing performs the evaluation using the layer 1/layer 2/layer 3 measurements.

According to an exemplary embodiment, the means for obtaining, the means for performing an evaluation, the means for providing, the means for performing a final decision, and the means for collecting are implemented by the processing circuitry 41, the memory circuitry 42 and the interface circuitry 43 of the control unit 40.

According to an exemplary embodiment, the layer 2/layer 3 measurements comprise at least one of the following: throughput and latency.

According to an exemplary embodiment, the layer 1 measurements and/or estimations for cellular and non-cellular radio performance characteristics comprise at least one of the following group: signal strength, signal quality, latency, throughput, and power.

According to an exemplary embodiment, the information supporting selection of a connection to cellular or non-cellular radio comprises at least one of the following group: operator policies and user preferences.

It is to be understood that the above description is illustrative of the invention and is not to be construed as limiting the invention. Various modifications and applications may occur to those skilled in the art without departing from the true spirit and scope of the invention as defined by the appended claims.

1. A method for use by a modulator/demodulator apparatus, the method comprising:
obtaining layer 1 measurements and/or estimations for cellular and non-cellular radio performance characteristics;
performing an evaluation based on at least the layer 1 measurements and/or estimations; and either
providing information on results of the evaluation to a connection manager located in an upper layer, for performing a final decision on selecting a connection to cellular or non-cellular radio, where the performed evaluation is for selecting a connection to cellular or non-cellular radio; or
performing a final decision on selecting a connection to cellular or non-cellular radio based on results of the evaluation and the information supporting said selection, where said information is obtained from the connection manager located in an upper layer for selecting the connection to cellular or non-cellular radio.

2. (canceled)

3. The method of claim 1, comprising:
collecting layer 2/layer 3 measurements in addition to the layer 1 measurements; and
performing the evaluation using the layer 2/layer 3 measurements in addition to the layer 1 measurements.

4. The method of claim 3, wherein the layer 2/layer 3 measurements comprise at least one of the following: throughput and latency.

5. The method of claim 1, wherein the layer 1 measurements and/or estimations for cellular and non-cellular radio performance characteristics comprise at least one of the following group: signal strength, signal quality, latency, throughput, and power.

6. The method of claim 1, wherein the information supporting selection of a connection to cellular or non-cellular radio comprises at least one of the following group: operator policies and user preferences.

7. The method of claim 1, wherein the modulator/demodulator apparatus comprises a common shared layer 2/layer 3 cellular/non-cellular architecture in which the method is performed.

8-10. (canceled)

11. An apparatus for use by a user equipment, the apparatus comprising at least one processor and at least one memory including computer program code, the at least one memory and the computer program code configured to, with the at least one processor, cause the apparatus at least to:
obtain layer 1 measurements and/or estimations for cellular and non-cellular radio performance characteristics;
perform an evaluation based on at least the layer 1 measurements and/or estimations; and either
provide information on results of the evaluation to a connection manager located in an upper layer, for performing a final decision on selecting a connection to cellular or non-cellular radio; or
perform a final decision on selecting a connection to cellular or non-cellular radio based on results of the evaluation and the information supporting said selection, where said information is obtained from the connection manager located in an upper layer for selecting the connection to cellular or non-cellular radio.

12. (canceled)

13. The apparatus of claim 11, the at least one memory and the computer program code configured to, with the at least one processor, cause the apparatus at least to:
collect layer 2/layer 3 measurements in addition to the layer 1 measurements; and
perform the evaluation using the layer 1/layer 2/layer 3 measurements.

14. The apparatus of claim 13, wherein the layer 2/layer 3 measurements comprise at least one of the following: throughput and latency.

15. The apparatus of claim 11, wherein the layer 1 measurements and/or estimations for cellular and non-cellular radio performance characteristics comprise at least one of the following group: signal strength, signal quality, latency, throughput, and power.

16. The apparatus of claim 12, wherein the information supporting selection of a connection to cellular or non-cellular radio comprises at least one of the following group: operator policies and user preferences.

17. A computer readable medium storing a computer program for a processing device, comprising software code portions, which, when the program is run on the processing device causes the device at least to:
obtain layer 1 measurements and/or estimation for cellular and non-cellular radio performance characteristics;
perform an evaluation based on at least the layer 1 measurements and/or estimations; and either
provide information on results of the evaluation to a connection manager located in an upper layer, for performing a final decision on selecting a connection to cellular or non-cellular radio; or
perform a final decision on selecting a connection to cellular or non-cellular radio based on results of the evaluation and the information supporting said selection, where said information is obtained from the connection manager located in an upper layer for selecting the connection to cellular or non-cellular radio.

18. (canceled)

19. The computer readable medium according to claim 17, wherein the program is directly loadable into an internal memory of the processing device.

20. The computer readable medium of claim 17, wherein the computer program further causes the processing device to:
collect layer 2/layer 3 measurements in addition to the layer 1 measurements; and
perform the evaluation using the layer 1/layer 2/layer 3 measurements.

21. The computer readable medium of claim 20, wherein the layer 2/layer 3 measurements comprise at least one of the following: throughput and latency.

22. The computer readable medium of claim 17, wherein the layer 1 measurements and/or estimations for cellular and non-cellular radio performance characteristics comprise at least one of the following group: signal strength, signal quality, latency, throughput, and power.

23. The computer readable medium of claim 17, wherein the information supporting selection of a connection to cellular or non-cellular radio comprises at least one of the following group: operator policies and user preferences.

24. The apparatus of claim 11, wherein the apparatus comprises:
a common shared layer 2/layer 3 cellular/non-cellular processing device; and
a layer 1 control processing device, a cellular physical hardware and a non-cellular physical hardware for performing the layer 1 measurements and/or estimations for cellular and non-cellular radio performance characteristics.

25. The apparatus of claim 11, wherein the apparatus comprises:
a common shared layer 1/layer 2/layer 3 cellular/non-cellular processing device, a cellular physical hardware and a non-cellular physical hardware; and
the at least one memory and the computer program code configured to, with the at least one processor, cause the apparatus at least to:
perform the layer 1 measurements and/or estimations for cellular and non-cellular radio performance characteristics.

26. The apparatus of claim 24, wherein the apparatus comprises:
a first communication unit for transferring the layer 1 measurements and/or estimations to the common shared layer 2/layer 3 cellular/non-cellular processing device; and
a second communication unit for transferring the information on the results of the evaluation to the connection manager located in the upper layer, and/or obtaining the information supporting selection of the connection to cellular or non-cellular radio from the connection manager located in the upper layer.
